(19) United States
(12) Patent Application Publication
(10) Pub. No.: US 2026/0350515 A1
(43) Pub. Date: Nov. 5, 2026

(54) SYSTEM FOR ADAPTIVE TRAINING WORKFLOW ORCHESTRATION

(71) Applicant: BANK OF AMERICA CORPORATION, Charlotte, NC (US)

(72) Inventors: Nipun Mahajan, Lawrenceville, NJ (US); Sushama Deepak Shelke, Mumba (IN); Jai A. Lilly, Gastonia, NC (US); Yogesh Raghuvanshi, Pennington, NJ (US); Amit Mishra, Chennai (IN); Saksham Jain, Haridwar (IN)

(73) Assignee: BANK OF AMERICA CORPORATION, Charlotte, NC (US)

(21) Appl. No.: 19/196,177

(22) Filed: May 1, 2025

(51) Int. Cl. G06Q 10/0633; G09B 5/02

(52) U.S. Cl. CPC G06Q 10/0633; G09B 5/02

(57) ABSTRACT

Systems, computer program products, and methods are described herein for adaptive training workflow orchestration. In various embodiments, a system includes an operational assessment AI agent configured to receive and process multi-source performance data associated with a user to generate a user portfolio. The system further includes an orchestration AI agent configured to dynamically generate a personalized training workflow based on the user portfolio, the workflow comprising one or more training modules selected according to the identified deficiencies and severity levels. The orchestration AI agent may deploy the training workflow to a user device, continuously monitor user interaction, and perform real-time adjustments to training difficulty, content intensity, and module sequencing based on observed engagement and task performance. The orchestration AI agent may further evaluate user outcomes and transmit feedback to the operational assessment AI agent for iterative refinement of future workflows.

### TECHNOLOGICAL FIELD

Example embodiments of the present disclosure relate to multi-agent artificial intelligence (AI) systems for sensing skill gaps, planning training interventions, and executing personalized gamified training workflows based on issue detection, role-based metrics, and historical performance data.

### BACKGROUND

Organizations typically rely on standardized training systems that are not dynamically responsive to real-time operational issues or individualized skill gaps. These systems often operate in isolation from the workflows they are intended to support, lacking integration with contextual performance data. Existing training models are generally linear, static, and role-agnostic, and do not adapt based on employee interactions, issue severity, or evolving compliance requirements.

Additionally, current solutions do not employ real-time sensing of operational incidents to trigger immediate and targeted training. They rely on periodic assessments or manual identification of deficiencies, which leads to delayed interventions, reduced training effectiveness, and inefficient allocation of learning resources. The lack of automation in training planning, the absence of contextual prioritization, and limited personalization contribute to diminished engagement and suboptimal knowledge retention.

Applicant has identified a number of deficiencies and problems associated with adaptive training orchestration. Many of these identified problems have been solved by developing solutions that are included in embodiments of the present disclosure, many examples of which are described in detail herein.

### BRIEF SUMMARY

Systems, methods, and computer program products are provided for real-time orchestration of personalized gamified training workflows using a multi-agent artificial intelligence architecture that detects operational issues, evaluates employee skill portfolios, and dynamically assigns targeted training modules based on issue severity and role-specific requirements.

In one aspect, a system for adaptive training workflow orchestration is presented. The system comprising: an operational assessment AI agent, wherein the operational assessment AI agent is configured to: receive multi-source performance data associated with a user; and process the multi-source performance data to generate a user portfolio, wherein the user portfolio comprises a contextual skill deficiency and an associated issue severity level for the user; an orchestration AI agent operatively coupled to the operational assessment AI agent, wherein the orchestration AI agent is configured to: dynamically generate a personalized training workflow for the user based on the user portfolio, wherein the personalized training workflow comprises training modules selected based on the contextual skill deficiency and the associated issue severity level for the user; deploy the personalized training workflow for the user via an end-point device; continuously monitor user interaction with the personalized training workflow; and dynamically adjust in real-time, a difficulty level, content intensity, and training module sequence associated with the personalized training workflow based on the user interaction.

In some embodiments, in deploying the personalized training workflow, the orchestration AI agent is further configured to: apply performance trigger structures based on completion of each task associated with the personalized training workflow.

In some embodiments, wherein the operational assessment AI agent is configured to: process the multi-source performance data using a graph neural network to model relationships among job roles, responsibilities, and performance indicators of the user.

In some embodiments, the orchestration AI agent is configured to: select the training modules using reinforcement learning based on at least one of historical training outcomes of the user, historical user engagement metrics of the user, historical training outcomes of peers, or historical user engagement metrics of the peers.

In some embodiments, the multi-source performance data comprises at least one of supervisory feedback, communication logs, task completion records, or quantitative performance metrics.

In some embodiments, the orchestration AI agent is further configured to: generate a personalized learning path for the user based on a skill knowledge graph encoding hierarchical relationships among competencies.

In some embodiments, the operational assessment AI agent is further configured to: determine the user's job level and role-specific responsibilities prior to identifying the contextual skill deficiency.

In some embodiments, in monitoring the user interaction, the orchestration AI agent is further configured to: monitor a task success rate, a time-on-task, a retry frequency, or a navigation behavior of the user.

In some embodiments, the orchestration AI agent is further configured to: generate a final performance score based on the user's completion of the training modules during progression through the personalized training workflow; and transmit the final performance score to the user via the end-point device.

In some embodiments, the orchestration AI agent is further configured to: generate a report comprising at least one of the final performance score, task-level results, and engagement metrics; and transmit the report as feedback to the operational assessment AI agent for use in adjusting future training workflows associated with the user.

In another aspect, a computer program product for adaptive training workflow orchestration is presented. The computer program product comprising a non-transitory computer-readable medium comprising code, which when executed, is configured to cause a processor to: receive, using an operational assessment AI agent, multi-source performance data associated with a user; and process, using an operational assessment AI agent, the multi-source performance data to generate a user portfolio, wherein the user portfolio comprises a contextual skill deficiency and an associated issue severity level for the user; dynamically generate, using an orchestration AI agent, a personalized training workflow for the user based on the user portfolio, wherein the personalized training workflow comprises training modules selected based on the contextual skill deficiency and the associated issue severity level for the user; deploy, using the orchestration AI agent, the personalized training workflow for the user via an end-point device; continuously monitor, using the orchestration AI agent, user interaction with the personalized training workflow; and dynamically adjust in real-time, using the orchestration AI agent, a difficulty level, content intensity, and training module sequence associated with the personalized training workflow based on the user interaction.

In yet another aspect, a method for adaptive training workflow orchestration is presented. The method comprising: receiving, using an operational assessment AI agent, multi-source performance data associated with a user; processing, using an operational assessment AI agent, the multi-source performance data to generate a user portfolio, wherein the user portfolio comprises a contextual skill deficiency and an associated issue severity level for the user; dynamically generating, using an orchestration AI agent, a personalized training workflow for the user based on the user portfolio, wherein the personalized training workflow comprises training modules selected based on the contextual skill deficiency and the associated issue severity level for the user; deploying, using the orchestration AI agent, the personalized training workflow for the user via an end-point device; continuously monitoring, using the orchestration AI agent, user interaction with the personalized training workflow; and dynamically adjusting in real-time, using the orchestration AI agent, a difficulty level, content intensity, and training module sequence associated with the personalized training workflow based on the user interaction.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for adaptive training workflow orchestration, in accordance with an embodiment of the invention;

FIG. 2 illustrates a high-level architecture for adaptive training workflow orchestration, in accordance with an embodiment of the invention; and

FIG. 3 illustrates a process flow for adaptive training workflow orchestration, in accordance with an embodiment of the invention.

### DETAILED DESCRIPTION

### Overview

Conventional enterprise training systems do not dynamically adapt to real-time operational performance or employee-specific skill deficiencies. These systems rely on static training content, manual assessments, and generalized scheduling that does not reflect the urgency or context of workplace incidents. As a result, training is frequently misaligned with actual needs, leading to inefficiencies in learning, reduced responsiveness, and wasted computing and human resources.

Embodiments of the invention address these limitations by providing a system that employs three specialized AI agents, operational assessment AI agent, orchestration AI agent, and module implementation AI agent, operating in a coordinated, real-time manner. The operational assessment AI agent performs real-time detection and contextual evaluation of operational issues by analyzing multi-source performance data, including identifying the associate involved, their job level, defined responsibilities at that level, and their demonstrated skill level in executing those responsibilities. The operational assessment AI agent ingests, and processes structured and unstructured data, including quantitative performance metrics, qualitative supervisory feedback, task completion records, and communication logs. Using Graph Neural Networks (GNNs), the operational assessment AI agent models interdependencies between roles, tasks, and performance indicators, while Reinforcement Learning (RL) is applied to adapt evaluation strategies over time based on training outcomes. This enables precise identification of skill deficiencies in context, allowing the system to determine both issue severity and the appropriate training response.

The orchestration AI agent receives structured outputs from the operational assessment AI agent, including the associate's job role, responsibility set, performance metrics, skill level, and context-specific issue severity. Based on this input, the orchestration AI agent selects and schedules an optimal training module tailored to the associate's current capability profile. The orchestration AI agent constructs a personalized learning path using skill knowledge graphs, which encode prerequisite relationships, role-specific skill requirements, and domain hierarchies for each associate. Using reinforcement learning, the orchestration AI agent selects the most effective training module from an available set by maximizing a reward function derived from observed training efficacy, associate engagement, and post-training performance indicators. The orchestration AI agent also continuously monitors associate interaction with the training content—such as time-on-task, task success rates, and input behavior—and dynamically adjusts the difficulty level, content intensity, or delivery sequence in real time. This results in an adaptive training experience aligned with both short-term learning objectives and long-term role-based competency development.

The module implementation AI agent execute the training workflows generated by the orchestration AI agent. The module implementation AI Agent is responsible for delivering training content to the associate in a structured, interactive, and gamified format. The module implementation AI agent manages the sequencing, presentation, and progression of training modules, and integrates adaptive mechanisms based on associate interaction patterns and real-time feedback. The module implementation AI agent monitors training engagement and task-level performance metrics, such as completion time, accuracy, retry frequency, and navigation behavior. Based on this data, the module implementation AI agent applies predefined adjustment rules or dynamically generated adaptations to pacing, instructional modality (e.g., scenario-based tasks, micro-assessments), or reinforcement cycles. Additionally, the module implementation AI agent manages the application of performance trigger structures tied to task completion, performance improvement, or engagement benchmarks. Performance triggers may be point-based, achievement-driven, or progression-unlocked, depending on organizational policy or training context. In cases where training is mandated by compliance or policy frameworks, the module implementation AI agent enforces completion checkpoints and certifies learning outcomes. Training execution is logged in a structured format to support post-training evaluation, skill progression tracking, and feedback loops into the operational assessment and orchestration AI agents for continued refinement of training strategies. As such, by replacing manual identification, planning, and delivery processes with a fully automated pipeline, the system reduces latency, minimizes redundant training efforts, and aligns training with live operational requirements.

Embodiments of the invention are implemented using a specifically configured set of computer-based components that operate together to perform functions not achievable through conventional training systems. The disclosed architecture employs distinct AI agents to carry out real-time analysis, planning, and execution of training workflows based on dynamic operational data. These functions are enabled by technical methods, including the use of graph neural networks to model interrelated performance attributes, reinforcement learning to optimize module selection, and knowledge graph traversal to construct role-specific learning paths.

The system continuously processes input from multiple structured and unstructured data sources, performs context-sensitive analysis, and responds through automated scheduling and delivery of interactive training modules. These operations are not performed in isolation, but as part of an integrated technical pipeline involving real-time data handling, adaptive computation, and state-based learning progression. The coordination of these AI agents results in a system that improves the efficiency of computer operations, such as reducing unnecessary data storage and network traffic by avoiding redundant training assignments, minimizing processor cycles through targeted content deployment, and reducing response latency through automated evaluation mechanisms.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “AI agent” may refer to a computational entity implemented in software, hardware, or a combination thereof, that is configured to perform one or more tasks autonomously or semi-autonomously by processing input data, applying algorithmic models—including but not limited to machine learning models—and generating corresponding outputs. An AI agent may operate in real time or in batch mode, and may be configured to interact with other system components, data repositories, or external systems. An AI agent may include, without limitation, logic for data ingestion, preprocessing, feature extraction, decision-making, prediction, classification, clustering, optimization, or reinforcement learning. The AI agent may be trained using supervised, unsupervised, semi-supervised, or reinforcement-based approaches and may employ models such as neural networks (including graph neural networks), decision trees, rule-based systems, probabilistic models, or hybrid architectures. The AI agent may include or interact with a state machine, policy engine, or other control mechanism to manage its behavior over time. An AI agent may be implemented as a discrete module or service, or as part of a larger composite system comprising multiple coordinated AI agents. The behavior of each AI agent may be context-aware and may evolve based on system feedback, new data inputs, or policy constraints. The AI agent may be configured to execute on local computing hardware, distributed computing systems, cloud-based infrastructure, or edge devices.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

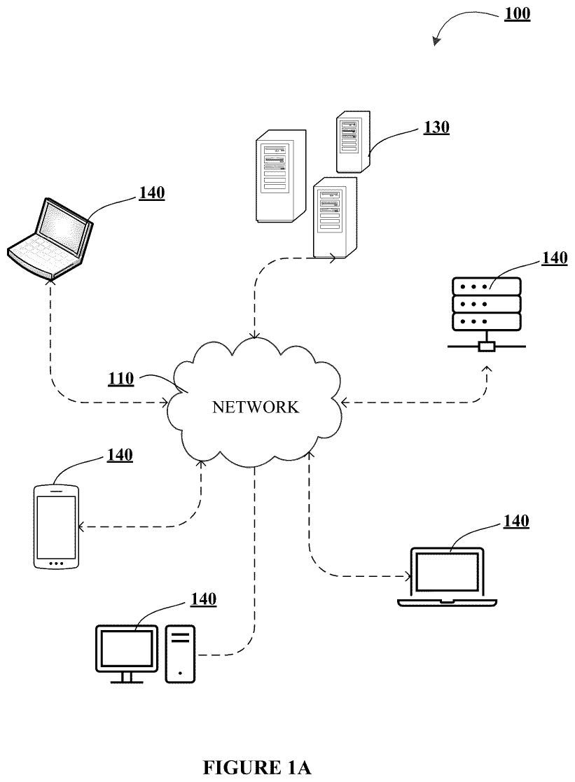

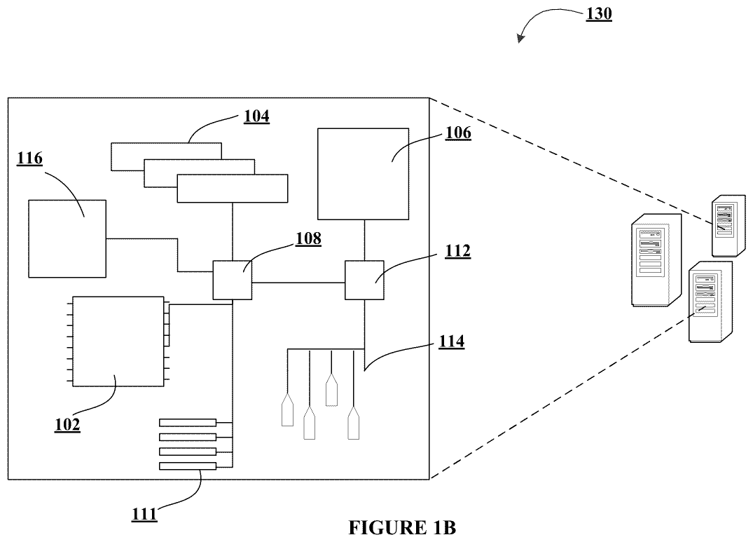

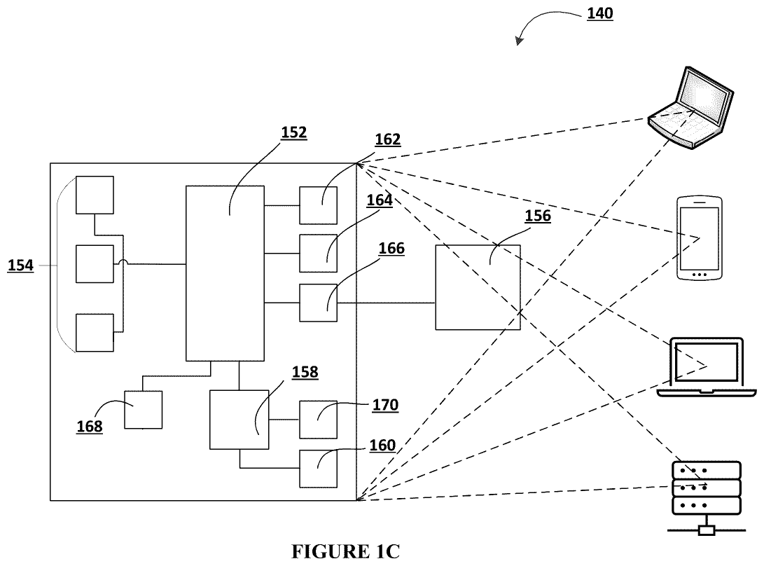

FIGS. 1A-1C illustrate technical components of an exemplary distributed computing environment for adaptive training workflow orchestration 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

In some embodiments, the system 130 may execute one or more AI agents, including the operational assessment AI agent, orchestration AI agent, and module implementation AI agent, as described herein. These agents may be deployed as discrete services or containerized modules or subsystem operating within a distributed computing architecture. Each AI agent may be instantiated on one or more processors 102 within the system 130 and may access memory 104 and storage device 106 to retrieve or persist intermediate data, models, knowledge graphs, and training content. The agents may be configured to operate in a coordinated manner through a shared orchestration layer or inter-process communication interfaces, facilitating seamless data flow and state propagation across components.

The operational assessment AI agent may interface with various data sources available within system 130 or across the network 110 to retrieve multi-source performance data. These sources may include enterprise systems, activity logs, supervisor annotations, task completion records, and other telemetry from connected end-point device(s) 140. The operational assessment AI agent may use the processor 102 to apply graph neural network models and reinforcement learning algorithms, supported by memory 104 for runtime execution and parameter storage. Outputs from this agent may be published to a message queue, shared memory region, or API endpoint accessible by the orchestration AI agent.

The orchestration AI agent may be configured to receive structured outputs from the operational assessment AI agent and to perform module selection and scheduling based on training efficacy models, skill knowledge graphs, and reinforcement-based optimization algorithms. The orchestration AI agent may use the high-speed interface 108 to access dynamically updated competency portfolios and module metadata stored in memory 104 or storage device 106. Training workflows generated by this agent may include content references, presentation parameters, pacing logic, and task order specifications, which are transmitted to the module implementation AI agent for delivery.

The module implementation AI agent may be deployed either on the system 130 or partially on end-point device(s) 140, depending on the use case and architectural design. For example, in thin-client configurations, the training content may be rendered and executed locally on the end-point device(s) 140 via display 156 and user interaction components (e.g., control interface 164), while adaptive decisions and content sequencing remain server-side on the system 130. In other cases, the full execution environment may reside on system 130, with the end-point device(s) 140 functioning primarily as display and input terminals.

Communication between the AI agents and system components may occur over the network 110, utilizing application layer protocols over TCP/IP or higher-level communication frameworks (e.g., gRPC, RESTful APIs, or message brokers). In some embodiments, agent interactions and data transactions are secured using authentication protocols and encryption, as described herein, and may be subject to access controls depending on user role, device configuration, and training context.

The described architecture enables real-time orchestration and delivery of adaptive training content by leveraging distributed processing capabilities of the system 130 and dynamic user interaction data from end-point device(s) 140. The modular design allows for scalability across enterprise environments, cloud-based deployments, or hybrid architectures, and supports integration with existing enterprise systems via API gateways, middleware, or event-driven interfaces.

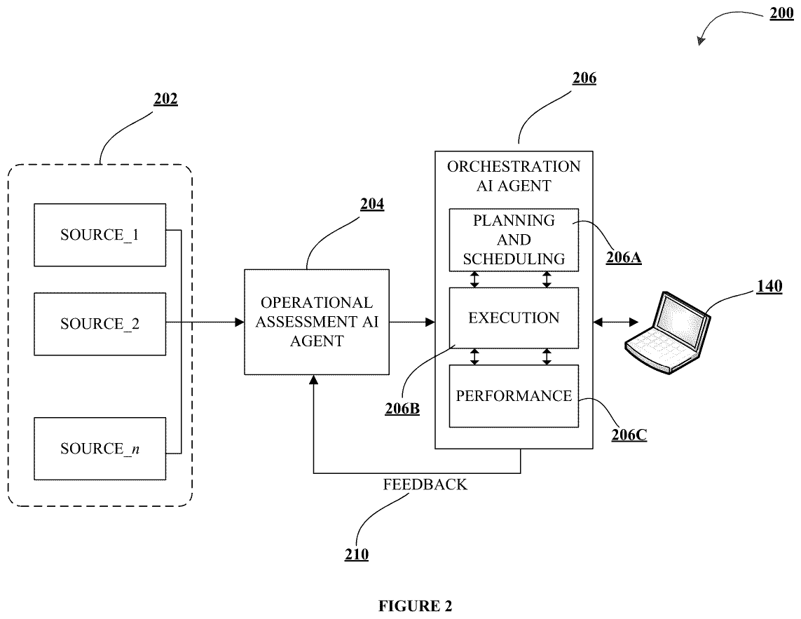

FIG. 2 illustrates a high-level architecture 200 for adaptive training workflow orchestration, in accordance with an embodiment of the invention. As shown in FIG. 2, the high-level architecture 200 includes a set of source systems 202, an operational assessment AI agent 204, and an orchestration AI agent 206. The architecture 200 further includes a feedback path 210 from the orchestration AI agent 206 to the operational assessment AI agent 204.

Source systems 202 may be configured to provide multi-source performance data associated with a user. In some embodiments, the multi-source performance data may include, but is not limited to supervisory feedback, communication logs, task completion records, quantitative performance metrics, and/or the like. Supervisory feedback may include qualitative observations, structured evaluations, or rating-based assessments provided by a user's direct or matrixed supervisors, typically in connection with performance reviews, post-task evaluations, or compliance monitoring activities. Communication logs may comprise transcripts or metadata associated with user interactions, such as emails, chat exchanges, call recordings, ticket resolutions, or messaging platform usage, which may be analyzed to infer behavioral patterns, communication efficacy, and task comprehension. Task completion records may reflect whether specific procedural, operational, or customer-facing tasks were performed, including timing, accuracy, and conformity with defined protocols. Quantitative performance metrics may include numerical indicators such as resolution rates, adherence to service-level agreements (SLAs), productivity scores, accuracy percentages, average handling times, escalation frequencies, or other task-specific or role-specific key performance indicators (KPIs).

The data may be obtained from multiple operational environments and may reflect various dimensions of user activity, including job-level responsibilities, role-based compliance adherence, historical learning outcomes, and/or the like. Job-level responsibilities may correspond to the expected duties, procedural scope, and performance thresholds associated with the user's designated role within the organizational structure. Role-based compliance adherence may indicate the degree to which a user has consistently performed in accordance with policy, regulatory, or procedural standards defined for that role. Historical learning outcomes may include prior training completion records, pre-and post-assessment scores, training engagement metrics, and subsequent on-the-job performance following training interventions. The data may be captured longitudinally to support time-based trend analysis or in real time to support immediate evaluation and intervention.

The source systems 202 may also include input from employee survey systems, peer review platforms, monitoring systems tracking task performance and communication quality, and/or the like. In some embodiments, employee survey systems may capture self-assessments, training satisfaction responses, perceived competency levels, or readiness ratings, which may be used to supplement objective performance data. Peer review platforms may provide evaluative input from colleagues or supervisors regarding a user's effectiveness in collaborative environments, communication proficiency, and adherence to role-based responsibilities. Monitoring systems may capture fine-grained behavioral data such as response latency, procedural compliance, frequency and accuracy of task execution, error recovery patterns, and communication sentiment (e.g., “communication-related metadata as described above). These systems may operate in real time or asynchronously and may contribute structured or unstructured data that the operational assessment AI agent 204 processes to build a comprehensive view of user performance and learning needs.

The operational assessment AI agent 204 is configured to receive and process the multi-source performance data provided by the source systems 202. In some embodiments, the operational assessment AI agent 204 may process this data to generate a user portfolio, which includes a contextual skill deficiency and an associated issue severity level for the user. The user portfolio may represent an individualized, dynamic portfolio reflecting the user's current capabilities, historical performance, and operational exposure exposure associated with the detected deficiency.

To construct the user portfolio, the operational assessment AI agent 204 may utilize a combination of learning techniques and structured models. In some embodiments, the agent may employ graph neural networks (GNNs) to model relationships among job roles, responsibilities, and performance indicators. These GNNs may be used to construct associate-skill knowledge graphs, in which nodes represent competencies, tasks, or domain-specific functions, and edges reflect observed or inferred dependencies among skills. The resulting graph structure allows the system to reason over skill hierarchies, detect interrelated deficiencies, and identify prerequisite skill gaps.

In some embodiments, the operational assessment AI agent 204 may further apply reinforcement learning to refine competency scoring over time. The agent may observe a user's training interactions, engagement patterns, and real-time performance metrics, and update the user's skill representation based on a reward function optimized for long-term performance improvement. These reward signals may include improvements in task accuracy, reduced intervention frequency, or increased training efficiency, thereby supporting continuous adjustment of competency scores within the user portfolio.

The operational assessment AI agent 204 may also integrate retrieval-augmented generation (RAG) techniques to support context-aware evaluation. For example, the agent may fetch historical logs from prior operational incidents involving similar skill deficiencies, roles, or workflows. These prior cases may be retrieved from structured databases or unstructured text corpora and used to contextualize current deficiencies based on incident similarity, frequency, and resolution success. This retrieval process supports a more informed assessment of issue severity and may also inform the orchestration AI agent's selection of appropriate training responses.

In some embodiments, the operational assessment AI agent 204 may incorporate a natural language understanding (NLU) model to extract contextual insights from unstructured or semi-structured data sources. The NLU model may process free-text content from supervisory comments, peer feedback, survey responses, and communication transcripts (e.g., chat, email, or call data) to derive semantic meaning and intent. The model may be configured to perform tasks such as sentiment analysis, intent recognition, and entity extraction in order to infer user disposition, identify behavioral trends, and associate observed language patterns with relevant skills or deficiencies. For example, the NLU model may detect uncertainty, noncompliance, or procedural misunderstanding in a user's communications and map these linguistic features to corresponding competencies within the associate-skill knowledge graph. The resulting structured insights may supplement the user portfolio and inform the orchestration AI agent 206 in generating more contextually relevant and personalized learning recommendations.

In some embodiments, the operational assessment AI agent 204 may also determine the user's job level and role-specific responsibilities prior to identifying the contextual skill deficiency. This may be based on metadata from organizational systems indicating the user's formal position, expected competency range, and training compliance status. The operational assessment AI agent 204 may integrate this information with real-time or longitudinal data to assess the relevance, frequency, and operational impact of observed deficiencies. The contextual skill deficiency may reflect a lack of competency in a specific task, process, compliance protocol, or communication scenario. The associated issue severity level may be based on one or more factors including the frequency of the issue, deviation from baseline expectations, downstream impact on operations, or recurrence across similar roles. In some embodiments, severity may be assigned using rule-based thresholds, probabilistic models, or exposure-weighted scoring mechanisms learned through training data.

The operational assessment AI agent 204 may output a structured representation of the user portfolio to the orchestration AI agent 206 for downstream processing. The user portfolio may be stored temporarily or persistently and may be updated iteratively as new data becomes available. The output may include one or more machine-readable data objects encapsulating identified skill deficiencies, severity level, role context, and other metadata relevant to training orchestration.

The orchestration AI agent 206 may be operatively coupled to the operational assessment AI agent 204 and may be configured to generate, deploy, monitor, and adapt a personalized training workflow based on a user portfolio comprising a contextual skill deficiency and an associated issue severity level. As shown in FIG. 2, the orchestration AI agent 206 may include three functional subsystems: a planning and scheduling module 206A, an execution module 206B, and a performance module 206C.

The planning and scheduling module 206A may be configured to construct a personalized training workflow using the data received from the operational assessment AI agent 204. In some embodiments, this module may reference a skill knowledge graph, which encodes hierarchical and dependency-based relationships among skills, competencies, and role-based expectations. The graph may include directed connections that define prerequisite knowledge and domain-specific progressions. The planning and scheduling module 206A may traverse this graph to identify a learning path that resolves the contextual skill deficiency using the shortest or most effective instructional sequence for the user's current proficiency level.

In some embodiments, the planning and scheduling module 206A may also apply reinforcement learning techniques to optimize module selection and ordering. A reward function may be trained on past training outcomes, historical engagement data, and peer-based comparisons to select training paths that have demonstrated measurable success. The planning and scheduling logic may incorporate severity level, competency weight, and training urgency to balance instructional depth with delivery efficiency.

The execution module 206B may be configured to deploy the personalized training workflow to the user via an end-point device 140. This execution module may handle the delivery of training content, user interface logic, session timing, and content version control. Training modules may be rendered through browser interfaces, mobile applications, desktop platforms, and/or the like, and may include interactive tasks, simulations, assessments, or instructional videos. The execution module 206B may support both synchronous and asynchronous training delivery, depending on organizational context or user availability.

In some embodiments, the execution module 206B may also manage performance trigger structures linked to module completion and task-level engagement. These performance triggers may include gamified point systems, visual progress indicators, achievement badges, or access to advanced content. Performance trigger allocation may be determined dynamically based on user performance and organizational configuration.

The performance module 206C may be configured to monitor the user's interaction with the deployed training modules and assess the user's training performance. The module may continuously collect and analyze user interaction data, including task success rates, time-on-task, retry frequency, and navigation behavior. This data may be used to compute a performance score and to update the user's skill trajectory. In some embodiments, the performance module 206C may also generate structured reports that include engagement metrics, module-level completion data, and inferred competency improvements.

In some embodiments, in real-time or near-real-time operation, the performance module 206C may provide feedback to other subsystems within orchestration AI agent 206, allowing the system to dynamically adjust the difficulty level, content intensity, or sequence of the remaining training modules. These adjustments may be made during a single training session or between sessions, enabling a continuous and adaptive learning experience. The performance module 206C may also transmit structured performance data back to the operational assessment AI agent 204 via feedback path 210, enabling continuous refinement of the user portfolio and future workflow personalization.

In some embodiments, the feedback path 210 may be configured to transmit structured performance data generated during or after execution of a personalized training workflow. This may include, but is not limited to, final performance scores, module-level outcomes, user engagement metrics, behavioral observations, and training progression data. The feedback transmitted via feedback path 210 may be used by the operational assessment AI agent 204 to update the user portfolio, including adjustments to competency scores, refinement of contextual skill deficiencies, and recalibration of issue severity levels. The feedback loop allows the system to iteratively learn from training outcomes and incorporate user-specific training efficacy into future evaluations. This enables the system to move beyond static or one-time assessments and to adopt a continuous learning and adaptation model.

The foregoing description of the high-level architecture 200 for adaptive training workflow orchestration, including its constituent components—source systems 202, operational assessment AI agent 204, orchestration AI agent 206, and feedback path 210—is intended to illustrate various embodiments of the invention and is not intended to limit the scope of the invention or the claims. The specific configuration, data flows, and functional responsibilities described herein may vary depending on implementation. Moreover, the described AI agents may be implemented as discrete modules, distributed services, or integrated processes within a shared system. Variations in system architecture, data processing sequences, or deployment environments may be made without departing from the scope of the claims. Accordingly, the architecture 200 is to be regarded as illustrative rather than limiting.

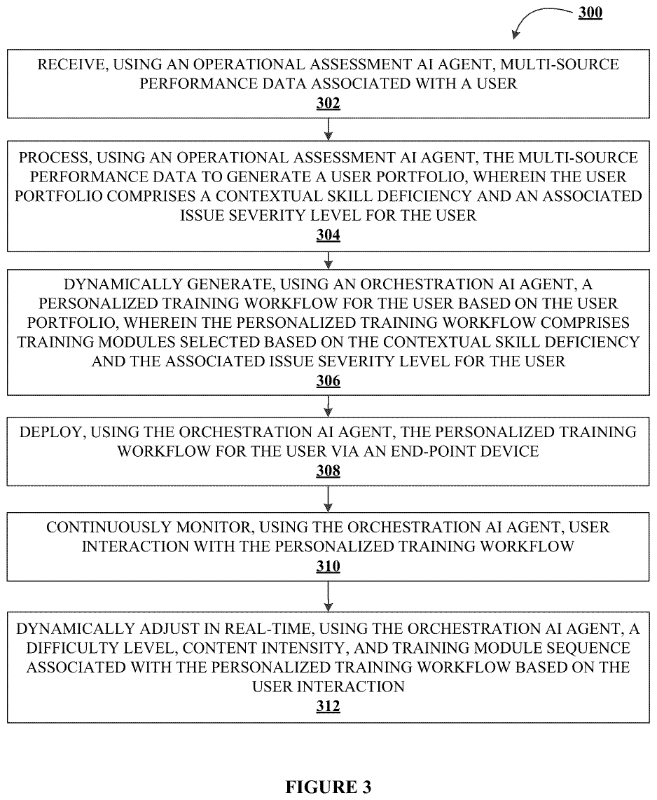

FIG. 3 illustrates a process flow 300 for adaptive training workflow orchestration, in accordance with an embodiment of the invention. The process flow 300 may be executed by the system (e.g., system 130) described with reference to FIGS. 1A-2. Each step in the process flow 300 may be performed by one or more specialized subsystems, including the operational assessment AI agent 204 and the orchestration AI agent 206. The system may operate in a distributed or integrated computing environment, where data is received from source systems 202, processed by the respective AI agents, and used to deliver and adapt training content to a user through a network-connected end-point device. The system may use shared data repositories, communication protocols, and orchestration logic to facilitate real-time evaluation, workflow generation, content delivery, and iterative refinement of training based on user behavior. Transitions between steps in the process flow 300 may be implemented as asynchronous service calls, event-based triggers, or scheduled background tasks, depending on system configuration and latency requirements. The components may be implemented using software modules, microservices, or containerized processes operating on cloud infrastructure or on-premises hardware

As shown in block 302, the process flow includes receiving, using an operational assessment AI agent, multi-source performance data associated with a user.

In some embodiments, the operational assessment AI agent may be configured to receive data originating from a plurality of source systems, such as workforce analytics platforms, learning management systems, compliance monitoring tools, task tracking systems, communication platforms, supervisory feedback systems, and/or the like, as described in FIG. 2. Such data may include structured and unstructured input reflecting the user's operational behavior, task performance, training history, communication interactions, and role-specific compliance adherence. In some embodiments, the data may further include user-generated inputs from survey systems, peer assessments, or real-time behavioral monitoring tools. These inputs may reflect subjective and objective performance characteristics, such as self-assessed readiness, observed collaboration effectiveness, or measured procedural compliance. The operational assessment AI agent may receive this data via APIs, data streams, or scheduled ingestion pipelines.

The received data may span across operational environments and may be collected over time to capture both real-time and historical user behavior. The diversity and granularity of the data allow the operational assessment AI agent to form a comprehensive and contextual view of the user's performance and competency portfolio, as described in FIG. 2.

As shown in block 304, the process flow includes processing, using an operational assessment AI agent, the multi-source performance data to generate a user portfolio, wherein the user portfolio comprises a contextual skill deficiency and an associated issue severity level for the user.

Upon receiving multi-source performance data, the operational assessment AI agent may apply a sequence of computational processes to derive a structured representation of the user's operational capability, referred to herein as a user portfolio. The user portfolio may include metadata reflecting the user's job level, role-specific responsibilities, and operational scope, as well as machine-generated inferences relating to performance gaps or behavioral patterns, as described in FIG. 2.

In some embodiments, the operational assessment AI agent may utilize GNNs to model relationships among roles, responsibilities, tasks, and observed performance indicators. Using this representation, the system may infer a contextual skill deficiency, which corresponds to a capability shortfall relevant to the user's assigned responsibilities. For example, the operational assessment AI agent may determine that a user consistently fails to complete a specific type of task within acceptable time or accuracy thresholds, or that the user displays communication behaviors inconsistent with role expectations. The operational assessment AI agent may also determine an issue severity level associated with the identified skill deficiency. Severity levels may be assigned based on factors such as the frequency and impact of the observed deficiency, the role criticality of the affected skill, or historical incident patterns. In some embodiments, the severity level may be computed using rule-based logic, probabilistic scoring models, or reinforcement learning techniques that continuously adjust based on the system's observation of prior training outcomes.

To support more accurate assessment, the operational assessment AI agent may incorporate RAG methods to access historical incident logs, as described in FIG. 2. These logs may be selected based on similarity to the user's current operational portfolio and may provide additional context for evaluating the relevance and potential impact of observed deficiencies. Additionally, natural language understanding (NLU) models may be used to process unstructured content, such as supervisory comments or user communications, to detect indicators of skill gaps, confusion, or policy non-compliance. These insights may be structured and incorporated into the user portfolio to support a richer and more context-sensitive evaluation of training needs.

As shown in block 306, the process flow includes dynamically generating, using an orchestration AI agent, a personalized training workflow for the user based on the user portfolio, wherein the personalized training workflow comprises training modules selected based on the contextual skill deficiency and the associated issue severity level for the user.

The orchestration AI agent may receive the user portfolio generated by the operational assessment AI agent, including data representing the user's job level, role-specific responsibilities, contextual skill deficiency, and associated issue severity level. Based on this input, the orchestration AI agent may dynamically generate a personalized training workflow tailored to the user's operational context and immediate training requirements. In some embodiments, the orchestration AI agent may reference a skill knowledge graph that encodes hierarchical relationships among organizational skills, including prerequisite structures, competency groupings, and task-specific capability links. The orchestration AI agent may traverse this graph to identify which training modules are relevant to the skill deficiency and to determine appropriate starting points and progression paths for the user.

To determine the most suitable training modules, the orchestration AI agent may apply reinforcement learning. The orchestration AI agent may be configured to select modules that maximize a reward function derived from prior user outcomes, observed training efficacy, engagement metrics, or competency improvement rates. In some embodiments, the agent may leverage historical training outcomes from similar users to guide module selection and sequence ordering. This supports adaptive training design that is informed by aggregated learning performance across the user population.

The personalized training workflow may include module definitions, instructional content, difficulty parameters, delivery formats, and completion logic. Each training module may be configured to address specific aspects of the detected deficiency and may include assessments, scenario-based tasks, simulations, or instructional material. The workflow may be optimized not only for skill coverage but also for efficiency and user engagement, especially in scenarios where high-severity issues require expedited remediation.

As shown in block 308, the process flow includes deploying, using the orchestration AI agent, the personalized training workflow for the user via an end-point device.

Following generation of the personalized training workflow, the orchestration AI agent may initiate deployment of the selected training modules to the user through one or more end-point devices. The deployment process may be configured to support role-specific scheduling preferences, accessibility requirements, and session management parameters.

The orchestration AI agent may package the training workflow into a deployable format that includes ordered module sequences, metadata describing difficulty levels, instructional modalities, and any embedded assessment criteria. In some implementations, training modules may be pushed to the user device through an application-specific interface, or accessed through a web-based or enterprise learning management platform integrated with the orchestration agent.

In some embodiments, the orchestration AI agent may apply performance trigger structures in connection with the training module deployment. These may include gamified mechanics such as point systems, progression tracking, digital badges, or certification triggers that correspond to task completion or engagement milestones. performance trigger logic may be predefined based on organizational policy or dynamically adjusted based on user profile attributes or training history.

The deployed workflow may support asynchronous or synchronous delivery depending on training type, system configuration, and user availability. In real-time environments, the orchestration AI agent may also control pacing and module access conditions during the training session to align with workflow constraints or resource availability. As described in FIG. 2, the orchestration AI agent interfaces with the end-point device as part of executing the training delivery function of the overall adaptive workflow system.

As shown in block 310, the process flow includes continuously monitoring, using the orchestration AI agent, user interaction with the personalized training workflow.

Once the personalized training workflow is deployed, the orchestration AI agent may begin real-time or near-real-time monitoring of the user's interaction with the training modules. This monitoring may include collecting interaction signals, user behavior patterns, and task-level performance metrics during the execution of each training module. The monitored data may include, but is not limited to, task success rate, time-on-task, retry frequency, and navigation behavior. For example, the orchestration AI agent may track how long a user spends on individual tasks, whether the user reattempts questions or assessments, whether navigation is linear or erratic, and how consistently the user progresses through training module content. These signals may be captured at the client level via instrumentation in the user interface, or at the server level via backend logging mechanisms.

In some embodiments, the orchestration AI agent may also evaluate engagement-related data such as drop-off points, inactivity periods, or frequency of skipped content. The captured interaction data may be stored locally, streamed to a remote system, or processed immediately to inform dynamic adjustments in the ongoing training session. Such continuous monitoring enables the orchestration AI agent to assess training effectiveness at a granular level, and to identify behavioral patterns that may signal confusion, disengagement, or content misalignment. The orchestration AI agent may associate observed behaviors with the user's user portfolio to enrich future assessments and workflow generation logic.

As described in FIG. 2, in specific embodiments, the orchestration AI agent may be responsible for managing both the delivery and interaction monitoring phases of the adaptive training workflow.

As shown in block 312, the process flow includes dynamically adjusting in real-time, using the orchestration AI agent, a difficulty level, content intensity, and training module sequence associated with the personalized training workflow based on the user interaction.

Based on the interaction data collected during training, the orchestration AI agent may apply adaptive logic to modify the ongoing training experience. The orchestration AI agent may evaluate user engagement and performance indicators—such as high retry frequency, prolonged task durations, or low task success rates—as signals for adjustment. In response, the orchestration AI agent may modify the difficulty level of the current module, simplify or escalate content complexity, or reorder subsequent training modules to better match the user's pace and proficiency.

In some embodiments, adjustments may include replacing a module with an alternative version targeting the same skill at a different complexity level, inserting supplemental instructional content, or deferring advanced topics until foundational skills are demonstrated. The orchestration AI agent may reference the skill knowledge graph used during workflow generation to maintain curriculum alignment while making real-time changes to the instructional path. Content intensity may be adjusted by modifying the cognitive load of tasks, the granularity of instruction, or the density of embedded assessments. Sequence adjustments may involve reordering modules to introduce foundational concepts earlier or delaying high-severity modules until adequate engagement or capacity is observed. These dynamic adjustments may be made incrementally or session-wide and may take into account cumulative learning signals from both current and prior training sessions. Adjustments may be informed by reinforcement learning algorithms, which update content selection and adaptation strategies based on observed training efficacy over time.

As described in FIG. 2, the orchestration AI agent is configured to execute real-time control over the training delivery process, informed by continuous user feedback and aligned with the system's objective of resolving contextual skill deficiencies.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for adaptive training workflow orchestration, the system comprising:
an operational assessment AI agent, wherein the operational assessment AI agent is configured to:
receive multi-source performance data associated with a user; and
process the multi-source performance data to generate a user portfolio, wherein the user portfolio comprises a contextual skill deficiency and an associated issue severity level for the user;
an orchestration AI agent operatively coupled to the operational assessment AI agent, wherein the orchestration AI agent is configured to:
dynamically generate a personalized training workflow for the user based on the user portfolio, wherein the personalized training workflow comprises training modules selected based on the contextual skill deficiency and the associated issue severity level for the user;
deploy the personalized training workflow for the user via an end-point device;
continuously monitor user interaction with the personalized training workflow; and
dynamically adjust in real-time, a difficulty level, content intensity, and training module sequence associated with the personalized training workflow based on the user interaction.

2. The system of claim 1, wherein, in deploying the personalized training workflow, the orchestration AI agent is further configured to:
apply performance trigger structures based on completion of each task associated with the personalized training workflow.

3. The system of claim 1, wherein the operational assessment AI agent is configured to:
process the multi-source performance data using a graph neural network to model relationships among job roles, responsibilities, and performance indicators of the user.

4. The system of claim 1, wherein the orchestration AI agent is configured to:
select the training modules using reinforcement learning based on at least one of historical training outcomes of the user, historical user engagement metrics of the user, historical training outcomes of peers, or historical user engagement metrics of the peers.

5. The system of claim 1, wherein the multi-source performance data comprises at least one of supervisory feedback, communication logs, task completion records, or quantitative performance metrics.

6. The system of claim 1, wherein the orchestration AI agent is further configured to:
generate a personalized learning path for the user based on a skill knowledge graph encoding hierarchical relationships among competencies.

7. The system of claim 1, wherein the operational assessment AI agent is further configured to:
determine the user's job level and role-specific responsibilities prior to identifying the contextual skill deficiency.

8. The system of claim 1, wherein, in monitoring the user interaction, the orchestration AI agent is further configured to:
monitor a task success rate, a time-on-task, a retry frequency, or a navigation behavior of the user.

9. The system of claim 1, wherein the orchestration AI agent is further configured to:
generate a final performance score based on the user's completion of the training modules during progression through the personalized training workflow; and
transmit the final performance score to the user via the end-point device.

10. The system of claim 5, wherein the orchestration AI agent is further configured to:
generate a report comprising at least one of the final performance score, task-level results, and engagement metrics; and
transmit the report as feedback to the operational assessment AI agent for use in adjusting future training workflows associated with the user.

11. A computer program product for adaptive training workflow orchestration, the computer program product comprising a non-transitory computer-readable medium comprising code, which when executed, is configured to cause a processor to:
receive, using an operational assessment AI agent, multi-source performance data associated with a user;
process, using an operational assessment AI agent, the multi-source performance data to generate a user portfolio, wherein the user portfolio comprises a contextual skill deficiency and an associated issue severity level for the user;
dynamically generate, using an orchestration AI agent, a personalized training workflow for the user based on the user portfolio, wherein the personalized training workflow comprises training modules selected based on the contextual skill deficiency and the associated issue severity level for the user;
deploy, using the orchestration AI agent, the personalized training workflow for the user via an end-point device;
continuously monitor, using the orchestration AI agent, user interaction with the personalized training workflow; and
dynamically adjust in real-time, using the orchestration AI agent, a difficulty level, content intensity, and training module sequence associated with the personalized training workflow based on the user interaction.

12. The computer program product of claim 11, wherein, in deploying the personalized training workflow, the code when executed, further causes the processor to:
apply, using the orchestration AI agent, performance trigger structures based on completion of each task associated with the personalized training workflow.

13. The computer program product of claim 11, wherein the code, when executed, further causes the processor to:
process, using the operational assessment AI agent, the multi-source performance data using a graph neural network to model relationships among job roles, responsibilities, and performance indicators of the user.

14. The computer program product of claim 11, wherein the code, when executed, further causes the processor to:
select, using the orchestration AI agent, the training modules using reinforcement learning based on at least one of historical training outcomes of the user, historical user engagement metrics of the user, historical training outcomes of peers, or historical user engagement metrics of the peers.

15. The computer program product of claim 11, wherein the multi-source performance data comprises at least one of supervisory feedback, communication logs, task completion records, or quantitative performance metrics.

16. The computer program product of claim 11, wherein the code, when executed, further causes the processor to:
generate, using the orchestration AI agent, a personalized learning path for the user based on a skill knowledge graph encoding hierarchical relationships among competencies.

17. The computer program product of claim 11, wherein the code, when executed, further causes the processor to:
determine the user's job level and role-specific responsibilities prior to identifying the contextual skill deficiency.

18. A method for adaptive training workflow orchestration, the method comprising:
receiving, using an operational assessment AI agent, multi-source performance data associated with a user;
processing, using an operational assessment AI agent, the multi-source performance data to generate a user portfolio, wherein the user portfolio comprises a contextual skill deficiency and an associated issue severity level for the user;
dynamically generating, using an orchestration AI agent, a personalized training workflow for the user based on the user portfolio, wherein the personalized training workflow comprises training modules selected based on the contextual skill deficiency and the associated issue severity level for the user;
deploying, using the orchestration AI agent, the personalized training workflow for the user via an end-point device;
continuously monitoring, using the orchestration AI agent, user interaction with the personalized training workflow; and
dynamically adjusting in real-time, using the orchestration AI agent, a difficulty level, content intensity, and training module sequence associated with the personalized training workflow based on the user interaction.

19. The method of claim 18, wherein the multi-source performance data comprises at least one of supervisory feedback, communication logs, task completion records, or quantitative performance metrics.

20. The method of claim 18, wherein the method further comprises:
processing, using the operational assessment AI agent, the multi-source performance data using a graph neural network to model relationships among job roles, responsibilities, and performance indicators of the user.
